(19) United States
(12) Patent Application Publication
(10) Pub. No.: US 2011/0120626 A1
(43) Pub. Date: May 26, 2011

(54) METHOD OF PRODUCING ULTRA FINE SURFACING BULK SUBSTRATE

(76) Inventor: Chung-Ping Lai, Hsinchu County (TW)

(21) Appl. No.: 12/622,435

(22) Filed: Nov. 20, 2009

(51) Int. Cl. B32B 37/10

(52) U.S. Cl. 156/150

(57) ABSTRACT

A novel method of producing sub-nanometer grade surface finishing substrates comprises the following steps of: producing a mother substrate which has ultra fine finished surface; a sacrificial layer being employed on a top of this layer being used to facilitate the depletion of finished product with this mother substrate; after finishing the sacrificial layer, a vacuum tool being used to deposit a thin layer on the top of sacrificial layer, wherein this sacrificial layer is remained as a surface of a finished product. To further increase a thickness of the thin layer, vacuum tool or an electroplating method are employed. After reaching a predetermined thickness, the fine surface finishing layer will be bonded with a bulk substrate; bonding of these two objects being done by vacuum bonding with elevated temperature and pressure; and therefore, a fixture is used.

### BACKGROUND OF THE INVENTION

1. Field of the Invention

The present invention relates generally to producing bulk metal substrates which is suitable for mass production and with good flatness and ultra fine surface finishing to the roughness of less than nanometer in scale.

2. Description of the Related Art

Bulk metal substrate with ultra-fine surface finishing to the range of nanometer even sub-nanometer is needed in many applications such as hard disc, optical lens, reflectors, mirrors and new generation of magnetic capacitors. The traditional way of producing metal substrates with nanometer scaled surface finishing requires long and expensive manufacturing processes such as a CMP (chemical mechanical polishing) or direct diamond surface cutting. These machining methods will require expensive capital investment as well as long processing time. To massively producing ultra fine finishing substrates, an in-expensive method with low production cycle time is disclosed in this invention.

### OBJECTIVES OF THE INVENTION

It is, therefore, the objectives of the present invention to provide a novel method to produce a nanometer/sub-nanometer scaled roughness bulk substrates.

Another objective of the present invention is to provide a method to produce electrically conductive metal substrate with ultra fine surface finishing.

Another objective of the present invention is to provide a method to reduce the process time needed to manufacture aforementioned substrates.

Another objective of the present invention is to provide a method to produce ultra fine surface finishing bulk substrates composing of different materials such as aluminum, copper, Nicole, iron, silver, platinum, molybdenum, metal alloy and metal composite materials.

Another objective of the present invention is to provide a method of producing substrate with ultra-fine patterned surface features without a need of using expensive photolithographic process.

To achieve above objects, the present invention provides a novel method of producing nanometer grade surface finishing substrates comprises the following steps of: producing a mother substrate which has ultra fine finished surface; a sacrificial layer being employed on the top of this surface and being used to facilitate the depletion of finished product with this mother substrate; after finishing the sacrificial layer, a vacuum tool being used to deposit a thin layer of material on the top of sacrificial layer, wherein this thin layer will be remained as a surface of a finished product. To further increase a thickness of the thin layer for ease of substrate handling and following manufacturing, the same vacuum tool or an electroplating method may be employed. After reaching a predetermined thickness suitable for continuing manufacturing, the fine surface finishing layer will be bonded with a bulk substrate; bonding of these two objects being done by vacuum bonding with elevated temperature and pressure; and therefore, a fixture is used.

### BRIEF DESCRIPTION OF THE DRAWINGS

These and other features, aspects, arrangements and advantages of the present invention will be understood better with regard to the following description, appended claims and accompanying drawings where:

FIGS. 1(a)-1(f) are schematic production flow charts which exhibit layer structure as well as sequence of this invention.

### DESCRIPTION OF THE PREFERRED EMBODIMENTS

The present invention will be described and explained in details with reference to its embodiments. Examples of the embodiments are illustrated in the accompanying diagrams. The diagram and flow chart is drawn for the ease of understanding and explanation of present invention only; the extensions of the drawing with respect to number, ratio, position, relationship, dimension of the parts to form the embodiment will be explained or will be within the skill of the art after the following description has been read and understood.

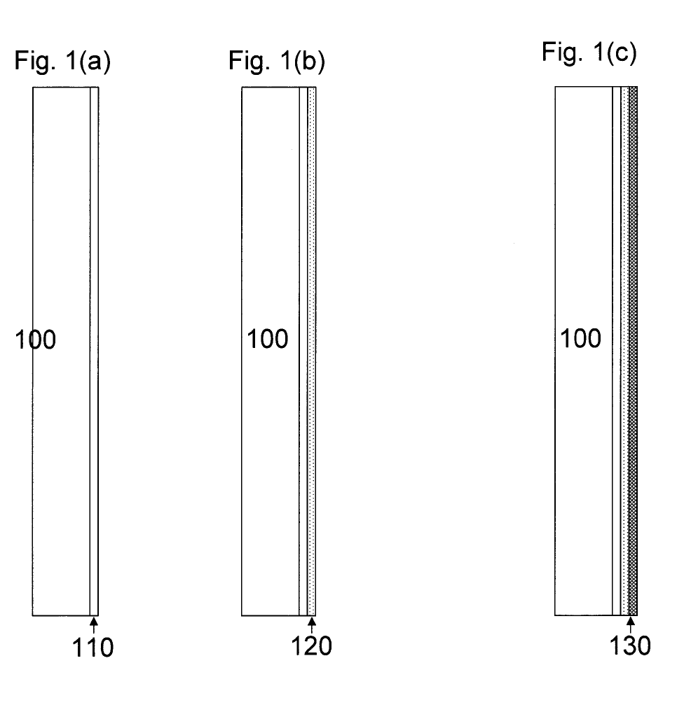

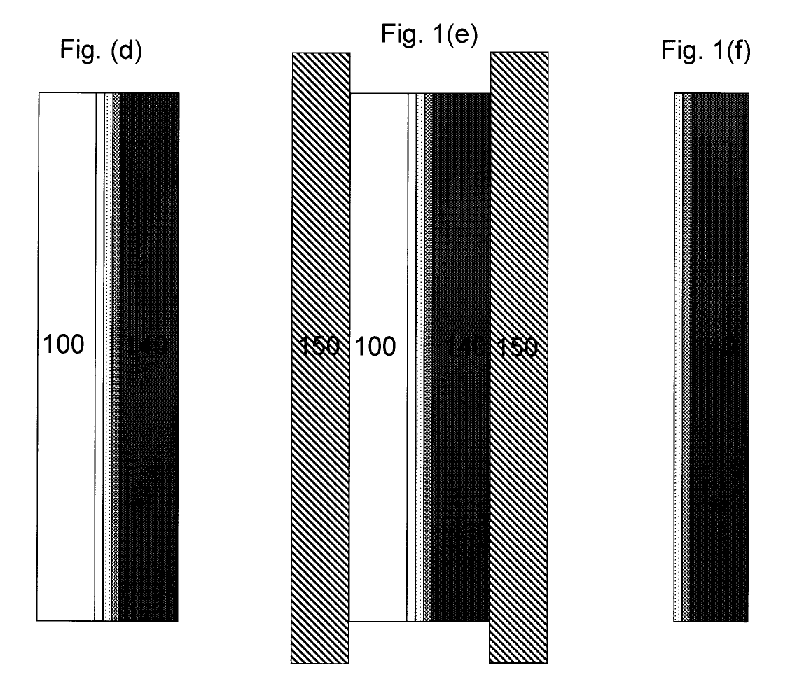

FIGS. 1(a)-1(f) shows the diagram of the production flow of the present invention. To start production of the present embodiment, a mother substrate (100) with very fine surface finishing is needed. If a patterned surface will be produced, a negative surface should be generated on the mother substrate in order to create the needed positive patterned surface. Since this mother substrate needs to be reusable, it is preferred that these substrates should be made of hard materials which possesses high abrasive resistance and withstands high processing temperature and pressure. Materials such as quartz, ceramics and high melting temperature metal alloy can be used as raw materials for mother substrates. Also, depending on the dimension of the products needed to be produced, a mechanical strengthening mechanism can be used on the reverse side of the mother substrate in order to increase the strength of the mother substrates and to survive in the cyclic production procedure.

After finish the preparation of mother substrates, a thin polymer (110) layer is applied on the surface of the mother substrate. This polymer layer served two important functions in the present invention. First function is to be used as a sacrificial layer for ease of depletion of final product with mother substrate after production finished. The second function is to be patterned by the conventional photolithographic method in case a very complicate surface is required in which the final surface features can not be finished with single pre-patterning on mother substrate. If such a photo patterning is required, a photosensitive polymer with high surface finishing quality can be used to serve this sacrificial application.

After applying this thin sacrificial layer, a vacuum deposition process such as evaporation, sputtering or ion beam deposition will be employed to deposit the surface layer (120) which will serve as surface layer of the final products. Owing to long history of development, every possible metallic material can be deposited. Furthermore, a conventional surface defects such as nodules and voids frequently encountered in the bulk substrates can be eliminated through this vacuum process by well management of processing in adequate temperature or process range. These types of defects are usually encountered in the conventional metal substrates which cannot be resolved by any machining methods since these defects can be embedded in the bulk materials. Usually and surely, after surface cutting or polishing, these embedded defects may be unearthed. This results in very low yield rate of the metallic substrates. Therefore, traditionally, to achieve nanometer surface finishing, manufacturers have to deposit a layer of foreign material with significant thickness on these metal substrates before polishing so the embedded defected will not be unearthed during polishing. Nevertheless, typical raw metallic substrates are very rough. A pre-polishing before deposition of foreign material is needed to ensure a full coverage of the foreign materials on the bulk metal substrates. Therefore, it is a long and expensive production to achieve a fine surface finishing metallic substrates because double polishing processes cannot be avoid in the traditional production method.

After vacuum deposition, to save cost and speed up layer thickness, an electroplating (130) can be applied to increase the thickness of vacuum deposited film. There is no need to use the same materials for layers 120 and 130 even for bulk substrate (140). Therefore, a composite which preserve superior electrical and mechanical property can be designed in this production method. To reach final bulk product, the electroplating is again very expensive and time-consuming. Therefore, a bulk substrate (140) is employed to be bonded by vacuum bonding method via applying proper heat and pressure in the high vacuum environment. To facilitate vacuum bonding, a pressurized fixture (150) may be used to clamp the combined layers as showed in FIG. 1 (e). After the heating and pressurized bonding process, the aforementioned nanometer roughness surface can be attached to the bulk substrate. Depending on the selection of materials of layer 130 and substrate 140, the vacuum bonding can be very robust which can withstand any mechanical deformation and achieve required electrical conduction for all possible applications. For difficult vacuum bonding metal, an intermediate material can be used to facility bonding. This intermediate material can form eutectic solution with the both layer 130 and substrate 140 or adhere both materials via surface inter-diffusion. After heating and pressurized bonding, the integrated substrates consisting of layers 120, 130 and substrate (140) are brought back to room temperature. The sacrificial layer (110) can be already depleted against surface (120) or can be depleted by mechanical tearing force exerted on mother substrate (100) and finished product. Since there is no abrasive and other mechanical damage can happen during this invented process, the mother substrate can be reused for many cycles. Also, through utilization of vacuum deposition process and sacrificial layer which reproduce the fine surface of the mother substrate, the final product can possess a fine surface finishing quality up to sub-nanometer roughness scale together with well defined mechanical and electrical properties suitable for aforementioned applications.

Thus, the present invention comprises the steps of: producing a mother substrate (100) which has ultra fine surface finishing; a sacrificial layer (110) being employed on a top of this mother substrate to facilitate the depletion of finished product with this mother substrate; after finishing the sacrificial layer, a vacuum tool being used to deposit a thin layer (120) on the top of sacrificial layer, wherein this sacrificial layer is remained as a surface of a finished product, to increase a thickness of the thin layer (120), the same vacuum tool or an electroplating method can be employed; after reaching a predetermined thickness, an available bulk substrate (140) being employed to be bonded with these deposited fine surface layers (120 & 130); bonding of these two objects being done by vacuum bonding at elevated temperature and pressure; and therefore, a fixture (150) is used.

The present invention has been described with particular reference to certain preferred embodiments. It should be understood that the foregoing description and examples are only illustrative of the present invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

What is claimed is:

1. A production method compromising the following steps: producing a mother substrate (100) which has ultra fine finished; a sacrificial layer (110) being employed on a top of this mother substrate to facilitate the depletion of finished product with this mother substrate; after finishing the sacrificial layer, a vacuum tool being used to deposit a thin layer (120) on the top of sacrificial layer, wherein this thin layer will be remained as a surface of a finished product; to increase thickness of the thin layer (120), the same vacuum tool or an electroplating method is employed; after reaching a predetermined thickness, an available bulk substrate (140) being employed to be bonded with these deposited fine surface layers (120 & 130); bonding of these two objects being done by vacuum bonding at elevated temperature and pressure; and therefore, a fixture (150) is used.

2. The production method according to claim 1, wherein the said mother substrate (100) is made of hard materials which surface is polished to nanometer scaled roughness. This mother substrate can be reused for extended cycles.

3. The production method according to claim 1, wherein the said sacrificial layer (110) is made of either photo-sensitive or non-photo-sensitive polymer materials. This layer can depleted by thermal oxidation or by mechanical forces.

4. The production method according to claim 1, wherein the said sacrificial layer (110) served to duplicate the fine surfacing finishing or pattern of mother substrate. By employing photo-sensitive material in the said sacrificial and photolithographic means, Very complicate surface feature can be developed on the surface of the finishing product through double patterning.

5. The production method according to claim 1, wherein the said sacrificial layer (110) is also served to deplete the mother substrate (100) and finished product without any harming to the surfaces of the mother substrates and finished products.

6. The production method according to claim 1, wherein the said sacrificial layer (110) can be stripped away by chemical solution, thermally decomposed during vacuum bonding process or depletion by mechanical force exerted on the mother substrate (100) and finished product.

7. The production method according to claim 1, wherein the said surface layer (120) can be produced by any conventional vacuum deposition process. The vacuum deposition process can be achieved by evaporation, sputtering, ion beam deposition, and chemical vapor deposition (either plasma assisted, thermal assisted or without any assisting means).

8. The production method according to claim 1, wherein the said surface layer (120) can be directly attached to the following bulk substrate (140) or via electroplating layer (130).

9. The production method according to claim 1, wherein the said surface layer (120) will duplicate the fine surface features of the sacrificial layer and permanently remain as surface of finished product. The surface features of the sacrificial layer is again duplicating the features of the said mother substrates.

10. The production method according to claim 1, wherein the said surface layer (120) can be same or different materials as the bulk substrate (140).

11. The production method according to claim 1, wherein the said electroplating layer (130) can be done by any known electroplating or electroforming methods.

12. The production method according to claim 1, wherein a bulk material (140) with either surface finishing or without surfacing finishing is used to be bonded with the aforementioned fine surface layer (120).

13. The production method according to claim 12, wherein the said bonding method can be done in vacuum or atmospheric pressure.

14. The production method according to claim 12, wherein the said bonding method can employee thermal heating and/or pressurizing on the said surface layers (120 and/or 130) and said bulk substrate (140).

15. The production method according to claim 12, wherein the said bonding method can be done by surface inter-diffusion of the said surface layers (120 and/or 130) and said substrate (140).

16. The production method according to claim 1, wherein the said finished product posses ultra fine surface finishing with surface roughness equal or below nanometer range.

17. The production method according to claim 1, wherein the said finished product can be a free standing object which robust enough to withstand mechanical deformation in all possible applications.

18. The production method according to claim 1, wherein the said finished product can be electrical conductive or electrical non conductive.
